(19) United States
(12) Patent Application Publication
(10) Pub. No.: US 2004/0197088 A1
(43) Pub. Date: Oct. 7, 2004

(54) System for presenting audio-video content

(76) Inventors: Ahmet Mufit Ferman, Vancouver, WA (US); M. Ibrahim Sezan, Camas, WA (US); Petrus J. L. van Beek, Camas, WA (US)

Correspondence Address: Kevin L. Russell, Suite 1600, 601 SW Second Ave, Portland, OR, 97204-3157, US

(21) Appl. No.: 10/404,206

(22) Filed: Mar. 31, 2003

(51) Int. Cl. H04N 5/76; H04N 5/225; H04N 5/781

(52) U.S. Cl. 386/117; 386/125

(57) ABSTRACT

A system for viewing audio-video content together with temporal information.

### BACKGROUND OF THE INVENTION

The present invention relates to modifying audio-video content.

The amount of video content is expanding at an ever increasing rate, some of which includes sporting events. Simultaneously, the available time for viewers to consume or otherwise view all of the desirable video content is decreasing. With the increased amount of video content coupled with the decreasing time available to view the video content, it becomes increasingly problematic for viewers to view all of the potentially desirable content in its entirety. Accordingly, viewers are increasingly selective regarding the video content that they select to view. To accommodate viewer demands, techniques have been developed to provide a summarization of the video representative in some manner of the entire video. Video summarization likewise facilitates additional features including browsing, filtering, indexing, retrieval, etc. The typical purpose for creating a video summarization is to obtain a compact representation of the original video for subsequent viewing.

There are three major approaches to video summarization. The first approach for video summarization is key frame detection. Key frame detection includes mechanisms that process low level characteristics of the video, such as its color distribution, to determine those particular isolated frames that are most representative of particular portions of the video. For example, a key frame summarization of a video may contain only a few isolated key frames which potentially highlight the most important events in the video. Thus some limited information about the video can be inferred from the selection of key frames. Key frame techniques are especially suitable for indexing video content.

The second approach for video summarization is directed at detecting events that are important for the particular video content. Such techniques normally include a definition and model of anticipated events of particular importance for a particular type of content. The video summarization may consist of many video segments, each of which is a continuous portion in the original video, allowing some detailed information from the video to be viewed by the user in a time effective manner. Such techniques are especially suitable for the efficient consumption of the content of a video by browsing only its summary. Such approaches facilitate what is sometimes referred to as “semantic summaries”.

The third approach for video summarization is to manually segment, semi-automatically segment, or otherwise identify the segments in some manner.

There are numerous computer based editing systems that include a graphical user interface. For example, U.S. Pat. No. 4,937,685 discloses a system that selects segments from image source material stored on at least two storage media and denote serially connected sequences of the segments to thereby form a program sequence. The system employs pictorial labels associated with each segment for ease of manipulating the segments to form the program sequence. The composition control function is interactive with the user and responds to user commands for selectively displaying segments from the source material on a pictorial display monitor. The control function allows the user to display two segments, a “from” segment and a “to” segment, and the transition there between. The segments can be displayed in a film-style presentation or a video-style presentation directed to the end frame of the “from” segment and the beginning frame of the “to” segment. The system can selectively alternate between the film-style and video-style presentation. Such a system is suitable for a video editing professional to edit image source material and view selected portions of the image in a film-style or video-style presentation. However, such a system is ineffective for consumers of such video content to view the content of the source material in an effective manner.

### BRIEF DESCRIPTION OF THE DRAWINGS

FIG. 1 is an exemplary illustration of a graphical user interface for presenting video and a time line.

FIG. 2 is an exemplary illustration of an alternative time line.

FIG. 3 is an exemplary illustration of another alternative time line.

FIG. 4 is an exemplary illustration of yet another alternative time line.

FIG. 5 is an exemplary illustration of another graphical user interface for presenting video and a time line.

FIG. 6 is an exemplary illustration of a graphical user interface for modifying the presentation of the video.

FIG. 7 illustrates different presentation modes.

FIG. 8 illustrates hierarchical data relating to a video.

FIG. 9 is an exemplary illustration of yet another alternative time line.

FIG. 10 is an exemplary illustration of yet another alternative time line.

FIG. 11 is an exemplary illustration of yet another alternative time line.

FIG. 12 is an exemplary illustration of yet another alternative time line.

FIG. 13 illustrates additional navigational options.

FIG. 14 illustrates a regular scanning time line.

FIG. 15 illustrates a summary scanning time line.

FIG. 16 illustrates summary scanning with a thumbnail index of visual indications.

FIG. 17 illustrates a video summarization with external segments.

FIG. 18 illustrates a technique for viewing the video segments.

FIG. 19 illustrates another technique for viewing the video segments.

FIG. 20 illustrates another technique for viewing the video segments.

### DETAILED DESCRIPTION OF THE PREFERRED EMBODIMENT

A typical football game lasts about 3 hours of which only about one hour turns out to include time during which the ball is in action. The time during which the ball is in action is normally the exciting part of the game, such as for example, a kickoff, a hike, a pass play, a running play, a punt return, a punt, a field goal, etc. The remaining time during the football game is typically not exciting to watch on video, such as for example, nearly endless commercials, the time during which the players change from offense to defense, the time during which the players walk onto the field, the time during which the players are in the huddle, the time during which the coach talks to the quarterback, the time during which the yardsticks are moved, the time during which the ball is moved to the spot, the time during which the spectators are viewed in the bleachers, the time during which the commentators talk, etc. While it may indeed be entertaining to sit in a stadium for three hours for a one hour football game, many people who watch a video of a football game find it difficult to watch all of the game, even if they are loyal fans. A video summarization of the football video, which provides a summary of the game having a duration shorter than the original football video, may be appealing to many people. The video summarization should provide nearly the same level of the excitement (e.g. interest) that the original game provided.

It is possible to develop models of a typical football video to identify potentially relevant portions of the video. Desirable segments of the football game may be selected based upon a “play”. A “play” may be defined as an sequence of events defined by the rules of football. In particular, the sequence of events of a “play” may be defined as the time generally at which the ball is put into play (e.g., a time based upon when the ball is put into play) and the time generally at which when the ball is considered out of play (e.g., a time based upon when the ball is considered out of play). Normally the “play” would include a related series of activities that could potentially result in a score (or a related series of activities that could prevent a score) and/or otherwise advancing the team toward scoring (or prevent advancing the team toward scoring).

An example of an activity that could potentially result in a score, may include for example, throwing the ball far down field, kicking a field goal, kicking a point after, and running the ball. An example of an activity that could potentially result in preventing a score, may include for example, intercepting the ball, recovering a fumble, causing a fumble, dropping the ball, and blocking a field goal, punt, or point after attempt. An example of an activity that could potentially advance a team toward scoring, may be for example, tackling the runner running, catching the ball, and an on-side kick. An example of an activity that could potentially prevent advancement a team toward scoring, may be for example, tackling the runner, tackling the receiver, and a violation. It is to be understood that the temporal bounds of a particular type of “play” does not necessarily start or end at a particular instance, but rather at a time generally coincident with the start and end of the play or otherwise based upon, at least in part, a time (e.g., event) based upon a play. For example, a “play” starting with the hiking the ball may include the time at which the center hikes the ball, the time at which the quarterback receives the ball, the time at which the ball is in the air, the time at which the ball is spotted, the time the kicker kicks the ball, and/or the time at which the center touches the ball prior to hiking the ball. A summarization of the video is created by including a plurality of video segments, where the summarization includes fewer frames than the original video from which the summarization was created. A summarization that includes a plurality of the plays of the football game provides the viewer with a shortened video sequence while permitting the viewer to still enjoy the game because most of the exciting portions of the video are provided, preferably in the same temporally sequential manner as in the original football video. Other relevant portions of the video may likewise be identified in some manner. Other types of content, such as baseball, tennis, soccer, and sumo, are likewise suitable for similar summarization including the identification of plays.

The present inventors considered the aforementioned identification of a “play” from a video and considered a traditional presentation technique, namely, creation of another video by concatenation of the “play” segments into a single sequence for presentation to the user. In essence, such techniques mask any underlying description data regarding the video, such as data relating to those portions to include, and provide an extracted composite. The data may be, for example, time point/duration data and structured textual or binary descriptions (e.g., XML documents that comply with MPEG-7 and TV-Anytime standards). While suitable for passive viewing by a user, the present inventors consider such a presentation to be inadequate for effective consumption of audiovisual material by a user. The user does not have the ability to conceptualize the identified subset of the program in the context of the full program. This is important for the user, because they should create a mental model of the temporal event relationships of the program that they are consuming (e.g., watching). For example, viewing a simple composite of a slam-dunk summary is a limited experience for viewing a sequence of events. In particular, the present inventors consider that a graphical user interface illustrating the temporal information regarding the location of the video segments within the original video enhances the viewing experience of the user and provides an improved dimension to the viewing experience.

It is also be to be understood that the identification of the plays, or otherwise segments of the video may be done using any type of automatic identification or otherwise manual identification.

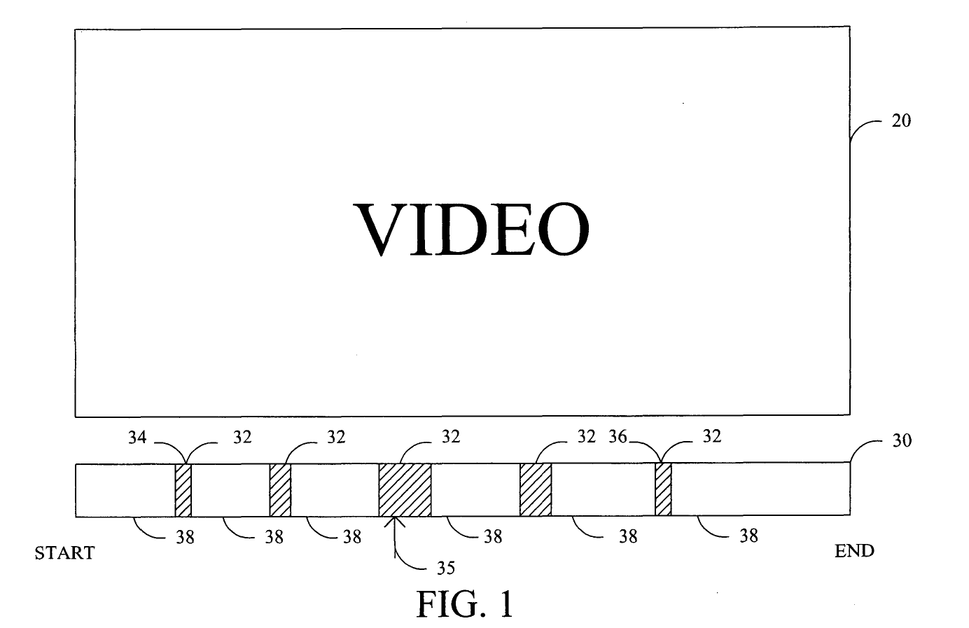

Referring to FIG. 1, the system may present the video content to the user in one or more windows 20 and may present a corresponding time line 30, which may be referred to generally as temporal information, representative of the entire video or a portion thereof with the identified play segments 32 or otherwise identified thereon. The segments 32 may relate to any particular type of content, such as for example, interesting events, highlights, plays, key frames, events, and themes. It is likewise to be understood that the segments of video described herein may be based upon any segment of the video, and not limited to “plays”. A graphical indicator 35 illustrates where in the time line 30 corresponds with the presently displayed video. The system may present the play segments 32 in order from the first segment 34 to the last segment 36. The regions between the play segments 32 relates to non-play regions 38, which are typically not viewed when presenting a summarization of the video consisting of play segments 32. The time line 30 may be a generally rectangular region where each of the plurality of segments 32 is indicated within the generally rectangular region, preferably with the size of each of the plurality of segments indicated in a manner such that the plurality of segments with a greater number of frames are larger than the plurality of segments with a lesser number of frames. Also, the size of the regions 38 between each of the plurality of segments may be indicated in a manner such that the regions 38 with a greater number of frames are larger than segments and regions with a lesser number of frames. Moreover, the size of each region 38 and segments 32 are preferably generally consistent with the length of time of the respective portions of the video. The indicator changes location relative to the time line as the currently displayed portion of the video changes.

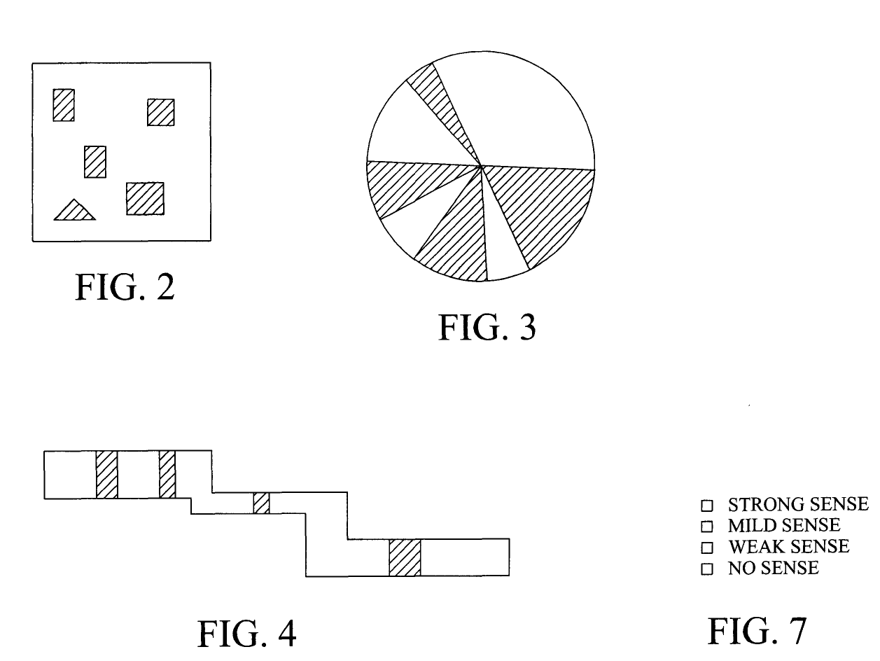

In an alternative embodiment, the relevant segments may be identified in any manner and relate to any parts of the video that are potentially of interest to a viewer with the total of the identified segments being less than the entire video. In essence, a plurality of segments of the video are identified in some manner. Referring to FIGS. 2, 3, and 4, alternative representations of the time line 30 for the video and segments of potential interest are illustrated.

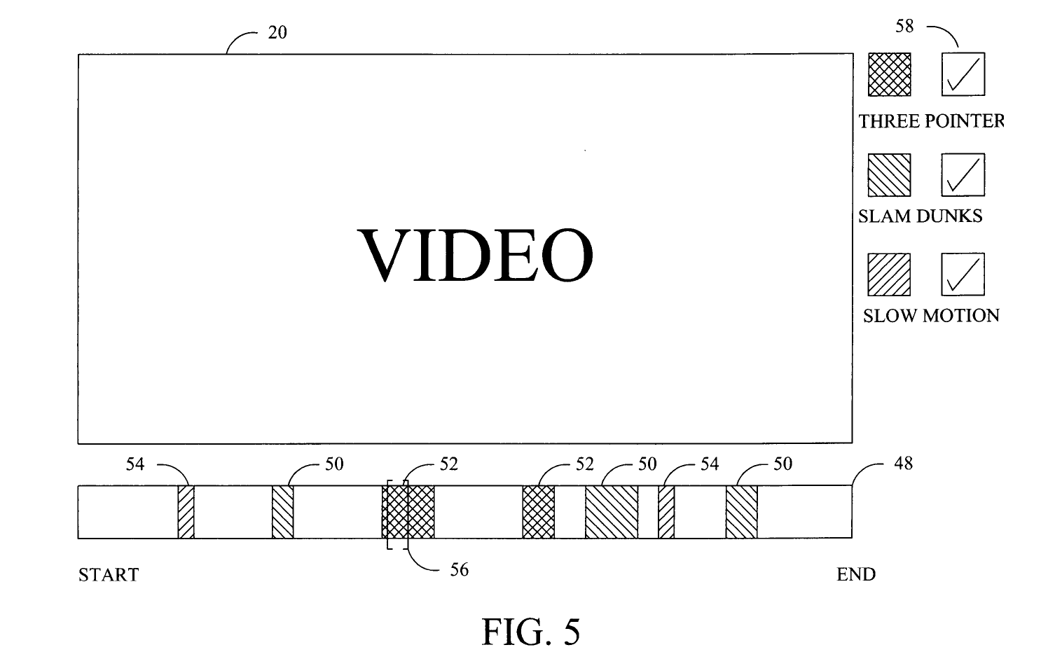

While the described system is suitable for indicating those portions of the video that are likely desirable for the user, the particular type of content that the time line indicates is unknown to the viewer. For example, during a basketball game the time line may select a large number of good defensive plays and only a few slam dunks. However, the particular viewer may be more interested in the slam dunks, and accordingly, will have to watch a significant series of undesired good defensive plays in order to watch the few slam dunks. Moreover, the system provides the viewer with no indication of when such slam dunks may occur, or whether all of the slam dunks for a particular video have already occurred. To overcome this limitation, the present inventors came to the realization that the time line should not only indicate those portions that are potentially desirable for the viewer, but also provide some indication of what type of content is represented by different portions of the time line. The indication may indicate simply that different portions relate to different content, without an identification of the content itself. Referring to FIG. 5, the time line 48 may indicate a first type of content with first visual indications 50, a second type of content with second visual indications 52, and a third type of content with third visual indications 54. Additional visual indications may likewise be used, if desired. Moreover, the indications may be provided in any visually identifiable manner, such as color, shade, hatching, blinking, flashing, outlined, normal bands, grey scale bands, multi-colored bands, multi-textured bands, multi-height bands, etc. To provide further interactivity with the video, the system may provide a selectable indicator 56 that indicates the current position within the time line, which may be referred to generally as temporal information, of a currently displayed portion of the video. This permits the user to have a more accurate mental model of the temporal-event relationships of the program they are viewing and interact therewith.

The selectable indicator 56 changes location relative to the time line 48 as the currently displayed portion of the video changes. The user may select the selectable indicator 56, such as by using a mouse or other pointing device, and move the selectable indicator 56 to a different portion of the video. Upon moving the selectable indicator 56, the video being presented changes to the portion of the video associated with the modified placement of the selectable indicator 56. This permits the user to select those portions of the video that are currently of the greatest interest and exclude those that are less desirable. The user may modify the location of the selectable indicator 56 to any other location on the time line 48, including other indicated portions 50, 52, 54, and the regions in between. Typically, the presentation of the video continues from the modified location.

The system may include a set of selectors 58 that permits the user to select which portions of the video should be included in the summarized presentation. For example, if the slow motion segments are not desired, then the user may unselect the slow motion box 58 and the corresponding slow motion regions of the time line 48 will be skipped during the summary presentation. However, it is preferred that the slow motion portions are still indicated on the time line 48, while not presented to the user in the summary presentation.

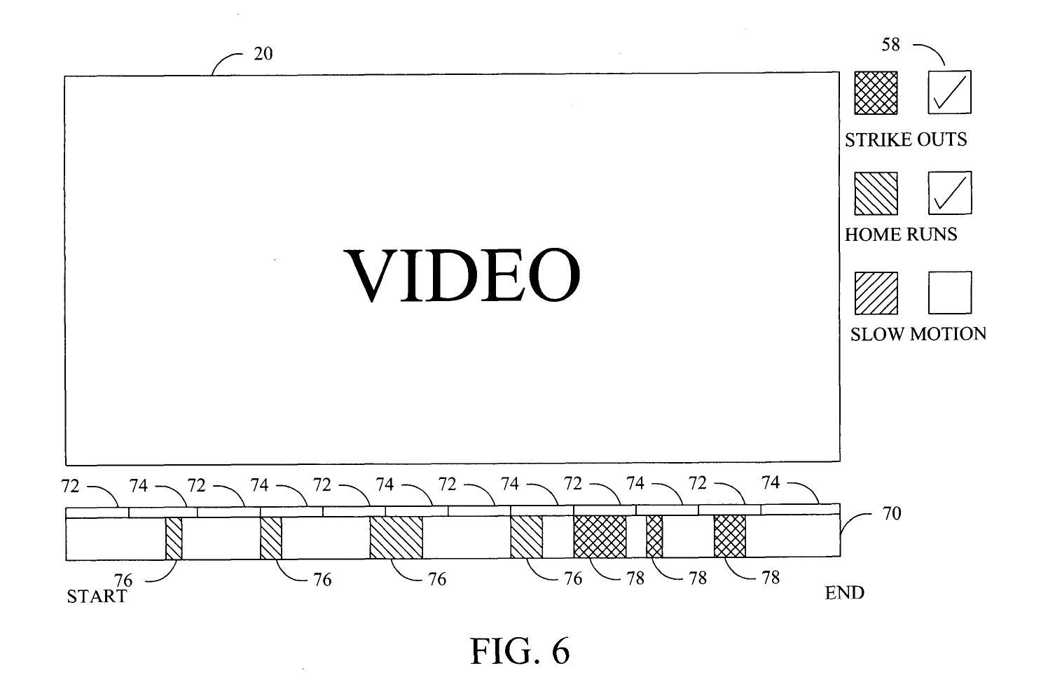

Referring to FIG. 6, a time line 70 may include layered visual bands. The layered visual bands may indicate overlapping activities (e.g., two different characterizations of the content of the video that are temporally overlapping), such as for example, the team that is in possession of the ball and the type of play that occurred, such as a slam dunk. For purposes of illustration, indicated portions 72 may be team A in possession and indicated portions 74 may be team B in possession. Also, the indicated portions 76 and 78 may be representative of different types of content.

The potential importance of displaying multiple different types of content, each having a visually distinguishable identifier, within the context of the video may be illustrated by the following example. Three point summary segments in the game of basketball made toward the end of the game have more significance, and the possession summary provides the user context about each of the three point segments without having to view the preceding portions. In essence, the three point segments reveal limited contextual information, but taken in combination with the entire program time line and overlaid “possession” summary, the summary provides a context to support the temporal-event relationship model.

As previously indicated, the interface may support changing the current playback position of the video. More than merely permitting the user to select a new position in the video, the present inventors determined that other navigational options may be useful in the environment of presenting audiovisual materials. The other navigational modes should correspond to a consistent set of behaviors.

Referring to FIG. 7, the system may include a strong sense mode which, if selected, modifies the functionality of the selectable indicator 56. In the strong sense mode, the user may modify the location of the selectable indicator 56 to another position. In the event that the user selects a location within a region between the indicated segments, the system automatically relocates the selectable pointer 56 to the closest start of the indicated segments. Alternatively, the system may automatically relocate the selectable pointer 56 to the next indicated segment, or the previous indicated segment. In the event that the user selects a location within an indicated segment, the system automatically relocates the selectable pointer 56 to the start of the indicated segment. In essence, the system assists the user in relocating the selectable pointer 56 to the start of one of the indicated segments. After viewing the selected indicated segment, the system goes to the next indicated segments, and so on, until presenting the last temporally indicated segment. In this manner the regions between the indicated segments will not be inadvertently viewed. This is also useful for summaries of short events occurring in a relatively long video, because the resolution of the cursor may make it difficult to manually position the indicator to the beginning of a segment.

The system may also include a mild sense mode which, if selected, modifies the functionality of the selectable indicator 56. In the mild sense mode, the user may modify the location of the selectable indicator 56 to another position. In the event that the user selects a location within a region between the indicated segments, the system automatically relocates the selectable pointer 56 to the closest start of the indicated segments. Alternatively, the system may automatically relocate the selectable pointer 56 to the next indicated segment, or the previous indicated segment. In the event that the user selects a location within an indicated segment, the system does not relocate the selectable pointer 56 within the indicated segment. In essence, the system assists the user in relocating the selectable pointer 56 to the start of one of the indicated segments if located between indicated segments and otherwise does not relocate the indicator. After viewing the selected indicated segment, the system goes to the next indicated segments, and so on, until presenting the last temporally indicated segment. In this manner the regions between the indicated segments will not be inadvertently viewed. This is also useful for summaries of reasonably long events occurring in a relatively long video, because the viewer may not desire to view the entire event.

The system may also include a weak sense mode which, if selected, modifies the functionality of the selectable indicator 56. In the weak sense mode, the user may modify the location of the selectable indicator 56 to another position. In the event that the user selects a location within a region between the indicated segments, the system does not relocate the selectable pointer 56 to the closest start of the indicated segments. In the event that the user selects a location within an indicated segment, the system does not relocate the selectable pointer 56 within the indicated segment. In essence, the system does not assists the user in relocating the selectable pointer 56 to the start of one of the indicated segments nor relocates the selectable pointer 56 within the region between indicated segments. After viewing the selected indicated segment, or otherwise the region between the indicated segments, the system goes to the next indicated segments, and so on, until presenting the last temporally indicated segment. In this manner the regions between the indicated segments are viewable while maintaining the summary characteristics. This is also useful for regions between indicated summaries that may be of potential interest to the viewer.

The system may also include a no sense mode which, if selected, modifies the functionality of the selectable indicator 56. In the no sense mode, the user may modify the location of the selectable indicator 56 to another position. In the event that the user selects a location within a region between the indicated segments, the system does not relocate the selectable pointer 56 to the closest start of the indicated segments. In the event that the user selects a location within an indicated segment, the system does not relocate the selectable pointer 56 within the indicated segment. In essence, the system does not assists the user in relocating the selectable pointer 56 to the start of one of the indicated segments nor relocates the selectable pointer 56 within the region between indicated segments. After viewing the selected indicated segment, or otherwise the region between the indicated segments, the system continues to present the video in temporal order, including regions between the indicated segments. In this manner the regions between the indicated segments together with the indicated segments, are viewable while maintaining the temporal graphical interface. It is to be understood that other navigational modes may likewise be used, as desired.

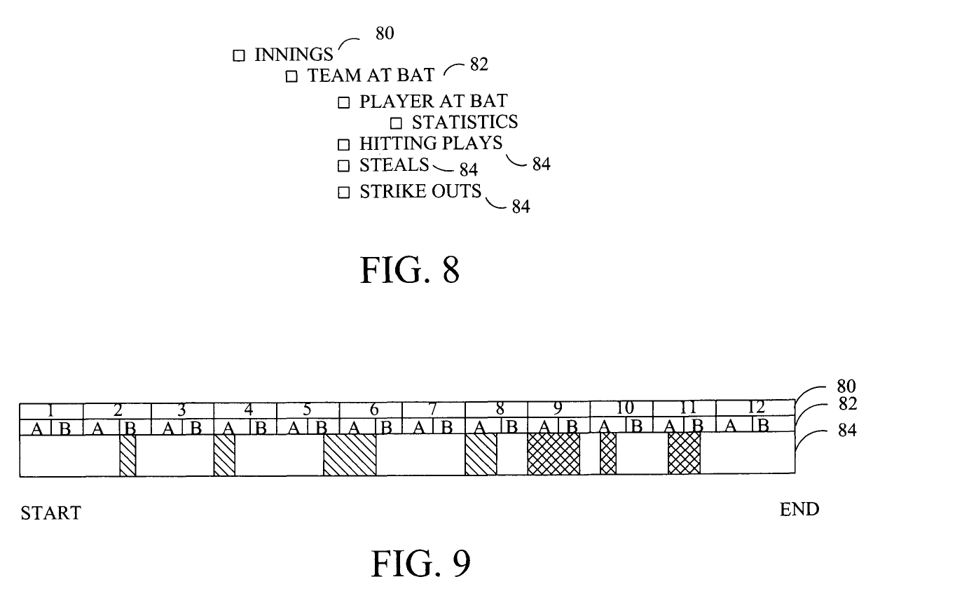

The present inventors came to the realization that descriptions related to video content may include summarization data and preferences, such as the MPEG-7 standard and the TV-Anytime standard. These descriptions may also include navigational information. Moreover, the data within the descriptions may be hierarchical in nature, such as shown in FIG. 8. The most rudimentary presentation of this data is to instantiate a single sequence or branch from the full collection. For instance, presenting a summary of the “slam dunks” for a basketball game. One technique for the presentation of the hierarchical material is to indicate each segment on the time line and thereafter present the sequence, as previously described. After considering the hierarchical nature of the data and the time line presentation of the video material, it was determined that the visual indications on the time line may be structured to present the hierarchical information in a manner that retains a portion of the hierarchical structure. Referring to FIG. 9, one manner of maintaining a portion of the hierarchical structure is to graphically present the information in ever increasing specificity where at least two levels of the hierarchy, preferably different levels, are presented in an overlapping manner. For example, in baseball the time line may include data from the innings 80, the team at bat 82 (e.g., team A, team B), and the plays 84 which may be further differentiated. In the event that the data has hierarchical or non-hierarchical temporal information with overlapping time periods, the temporal information may be displayed in such a manner to maintain the differentiation of the overlapping time periods.

In general, the time line may include multiple layers in a direction perpendicular to the length of the time line. This multiple level representation permits more information regarding the content of the video to be presented to the user in a more compact form and consistent format. The levels may be of different widths and heights, as desired. Also, the techniques for presenting the information in the time line may be associated with a particular layer of the time line. These layers may be managed, in the graphical user interface, as windows that may be minimized, reordered, shrunken or expanded, highlighted differently, etc. Also, the time line layering allows the particular presentation technique for each layer to be dynamically reconfigured by the user.

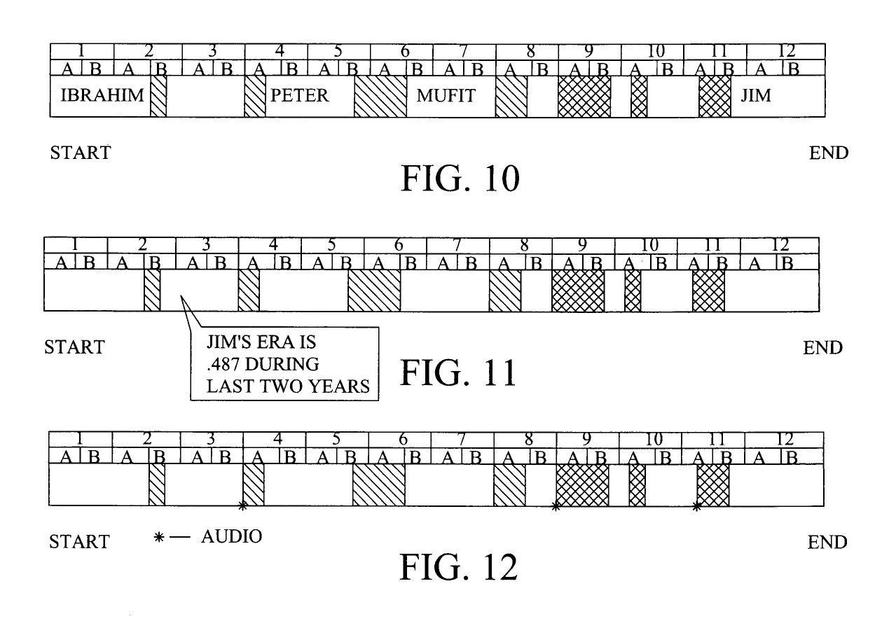

Referring to FIG. 10, to further annotate the time line textual information may be included therein. The textual information may, for example, include the name of the summary segment overlaid on the associated band in the time line. For example, in a football game, the current “down” may be shown. Referring to FIG. 11, textual information may also be presented as floating windows that pop up when the user brings the cursor over the associated segment. For example, in a baseball game, the user may move the cursor over the player-at-bat summary to learn who is batting in each segment, etc. Referring to FIG. 12, audible information may be presented together with the presentation of the video and temporal information. For instance, in a baseball game, the last-pitch-for-player-at-bat and the last-pitch-of-inning, may be associated with distinct audio clips that are played back at the beginning or otherwise associated with these particularly interesting plays.

The techniques discussed herein may likewise be applied to audio content, such as for example, a song, a group of songs, or a classical music symphony. Also, the techniques discussed herein may likewise be applied to audio broadcasts, such as commentary from national public radio or “books on tape”. For example, the first paragraph, medical paragraphs, topical information, etc. may be summarized. Moreover, the techniques discussed herein may likewise be applied to audio/visual materials.

The strong sense, mild sense, weak sense, and no sense (see FIG. 7) navigation selections permit enhanced interactivity with the audiovisual material. However, such navigational selections are cumbersome and may not provide the functionality that may be desired by consumers of audiovisual materials. To provide an enhanced experience to consumers of audiovisual summaries additional navigational functionality should be provided, where the functionality is associated with the visual interface presented to the user.

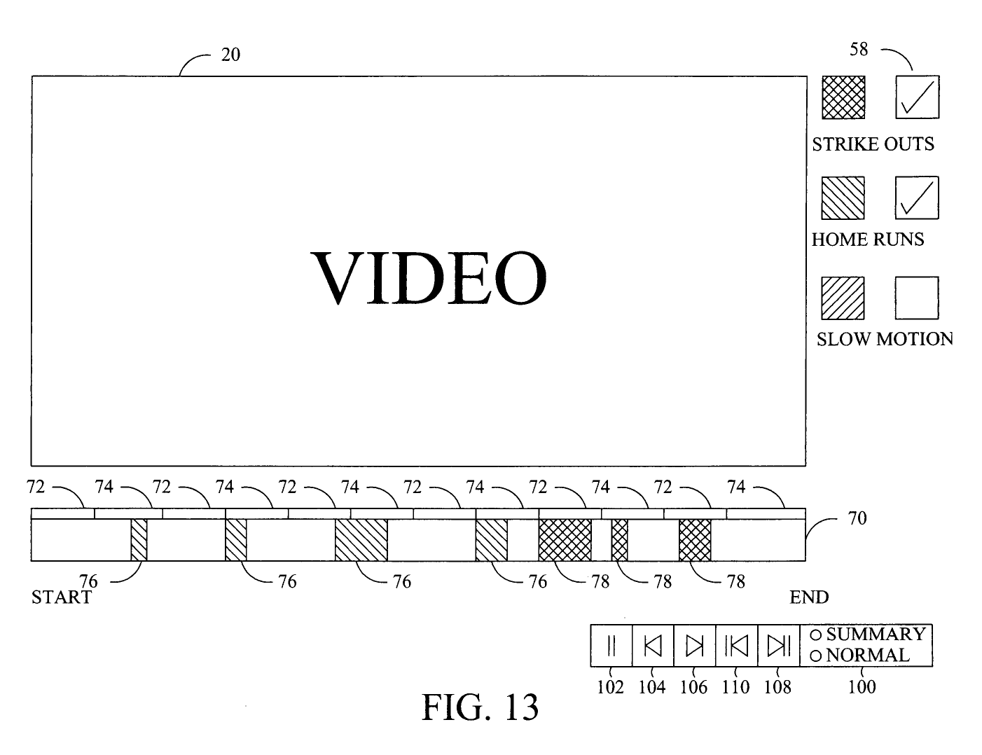

Referring to FIG. 13, a summary/normal button 100 selection is provided to enable the user to select between the summary presentation (e.g., primarily the summary materials) and the normal presentation (e.g., include both the summary materials and non-summary materials) of the audiovisual materials. A play/pause button 102 begins playback from the current position or pauses the playback at the current position if the program is already playing. A reverse skip button 104 and a forward skip button 106 cause the program to skip rearward or skip forward in the audiovisual content a predetermined time duration or otherwise to another summary portion.

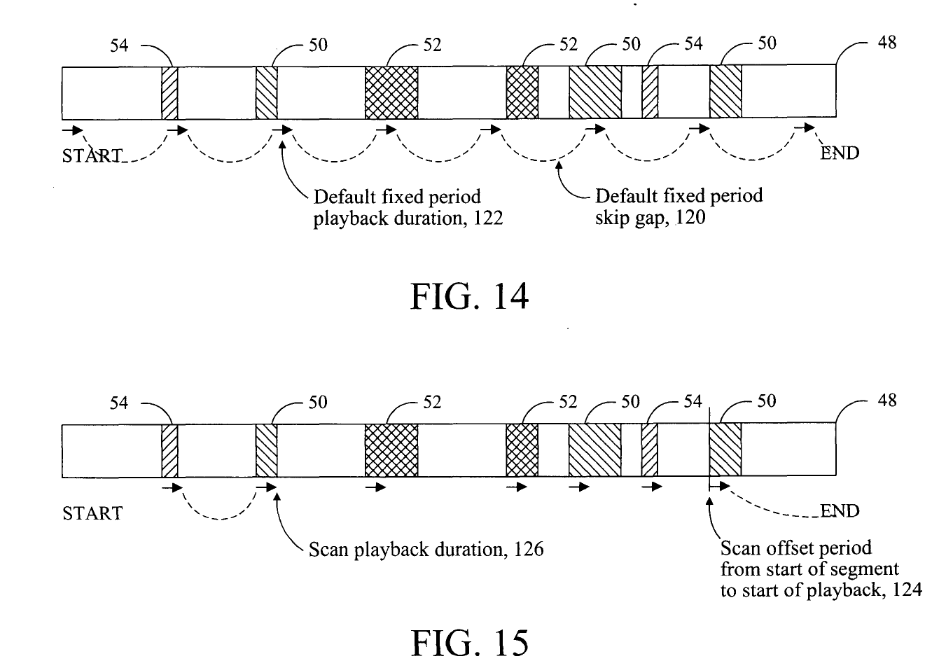

To reduce the time necessary for a user to consume a program the user may use a forward scan button 108 or a reverse scan button 110. Referring to FIG. 14, the forward scan button 108, when coupled with the normal playback 100, may use a predetermined period of time to determine the amount to advance 120 and another predetermined period of time of the short playback portion 122. In essence, each portion is displayed briefly before jumping to the next segment, unless the user decides to terminate the scan and resumes either normal or summary playback. It will be noted that this technique does not make use of the program summary description.

Referring to FIG. 15, the forward scan button 108, when coupled with the summary playback 100, may use the summary description depicted in the scroll bar to determine the amount to advance 124 and another predetermined period of time of the short playback portion 126. In essence, each summary portion is displayed briefly before jumping to the next segment, unless the user decides to terminate the scan and resumes either normal or summary playback. It will be noted that this technique makes use of the program summary description. Different techniques may be used to determine the offset into the program segment as well as the duration of the playback. For example, the offset and duration may be based on the program description or they may be based on a statistical analysis of the segment time boundaries. The example shown in FIG. 15 illustrates an offset of zero seconds (n) and a playback duration at an arbitrary number of seconds. That is, the viewer previews the first n seconds of each of the summary segments.

Another technique to dynamically determine the offset and duration may be by permitting the user to configure the scanning parameters. For instance, the user may press the play or skip button prior to activating the scan operation. Then if the time between pressing the play button (or skip) and pressing the scan button is within a reasonable range, this duration may be used as the scan playback duration parameter. Alternatively, the user may manually select the duration and/or offset parameter. Similarly, the same techniques may be used for the reverse scan button 110.

The user interface may likewise permit the configuration of other scanning operations. For example, the scanning modes may be activated by pressing the skip buttons 104 or 106 for a greater than a “hold” period of time, or the skip buttons 104 or 106 may have a “repeat key” behavior that is equivalent to being in the respective scan modes. The scan modes may be used as a fundamental technique for consuming the program, or as a rapid advance feature which will position the program for further operations. The scan mode may be terminated by any suitable action, such as for example, pressing another button while in the scan mode and/or activating another navigational option (e.g., play, reverse skip, forward skip, etc.).

An navigation example is described, for purposes of illustration, with respect to a baseball viewer that is interested in advancing to and watching all the plays of the game in which their favorite player is playing.

(a) The viewer activates the forward scanning mode by pressing the scan button. The viewer watches the program, waiting to detect their favorite player in the action, at which point they enter normal playback mode by pressing the play button.

(b) The game is then played back at normal rate without skipping or scanning anything. When the player is no longer in the action, the user may return to step (a), or they may,

(c) enter summary playback mode by pressing the summary/normal button 100. The game is played back in summary mode, just displaying the program summary segments. When the game becomes dull the player may return to step (a). Or if the favorite player returns to action, the user may

(d) re-enter normal (default) playback mode by pressing the summary/normal button. This puts the user back into step (b).

The combined effect of the improved navigational functionality together with the visual information provides a powerful user interface paradigm. Several effects may be realized, such as for example, (a) the visual cues facilitate the navigational process of finding specific program locations, (b) the combination of visual cues and navigation components conveys an impression of the “big picture” in the essence of the whole time line, and (c) the combination forms a feedback loop where the visual cues provide the intuitive feedback for the operation of the navigation controls. As it may be appreciated, the visual cues reinforce the commands and operations activated by the user, giving a strong feedback to the user. For instance, as the user activates the scanning operation, they will observe the scroll bar behavior depicting the scanning action. This in conjunction with the constantly updating main viewing area, gives a clear impression to the user of exactly what the system is doing. This likewise gives the user a stronger sense of control over the viewing experience.

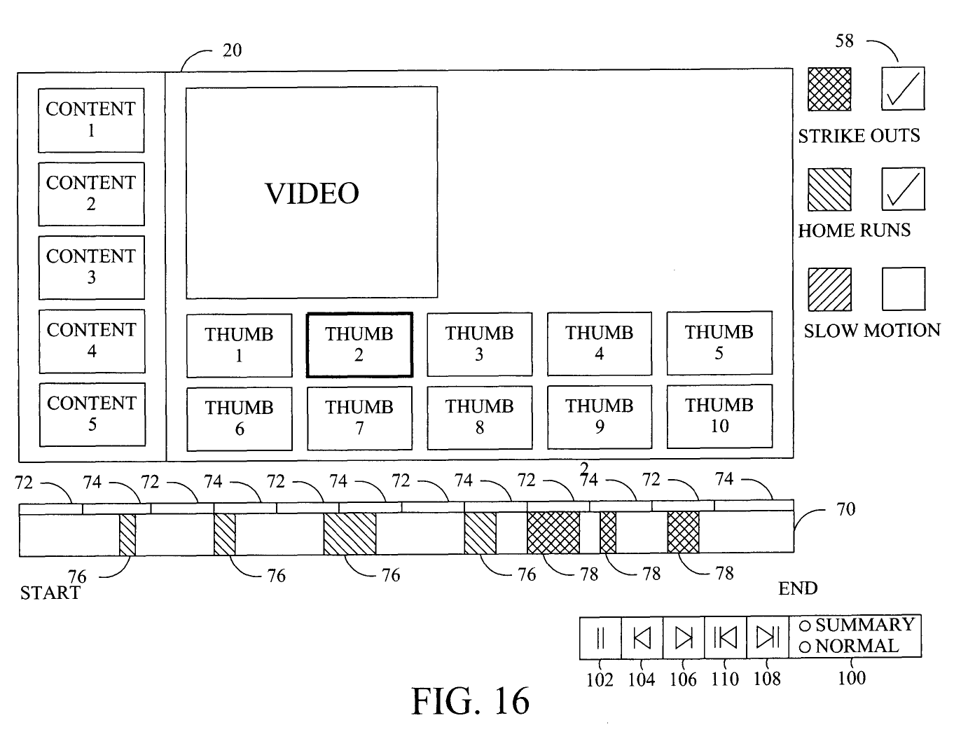

Referring to FIG. 16, the indexed mode of the program summaries may likewise be associated with thumbnail images that are graphical indices into the program time line, which further enhance the viewing experience. The thumbnail images are associated with respective summary segments, and may be key frames if desired. In addition, the thumbnails presented may be dynamically modified to illustrate a selected set proximate the portion of the program currently being viewed. Also, the thumbnail associated with the summary segment currently being viewed may be highlighted.

As it may be observed, during normal playback the program will highlight thumbnails at a rate based on the different gaps between each segment, which is typically irregular. However, when the program is played back in summary scanning mode, the highlighted thumbnails will advance at a regular pace from segment to segment. This regular (or linear) advancing of the thumbnail indices is a graphical mapping of the irregular (non-linear) advancement of the actual program. That is, the program is playing back in an irregular sequence, while the visual cues are advancing at a regular rate.

The various navigational operations described herein, expanded by their specific configuration parameters, makes possible a large number of complex navigation sequences. Depending on the user, the program genre, and/or the perspective the user has on a particular game (or program), there may be a wide variety of combinations that the user would like to include in a “macro” type navigation function (or button). A customized button (or function) may be provided for the user to perform a desirable sequence of operations. A sample list of navigation operations and their configuration parameters is illustrated below:

| Navigation Operation | Configuration Parameters |
|---|---|
| Regular Skip | Direction |
| | Period of time to advance/retreat |
| | Audio and video fade in periods |
| Smart Skip | Direction |
| | Number of segments to advance/retreat |
| | Segment “theme” patterns (used to filter segments |
| | within summary) |
| | Period of time to offset into segment |
| | Base of offset (start or end) |
| | Audio and video fade in periods |
| Regular Scan | Direction |
| | Period of time to advance/retreat |
| | Period of time to playback |
| | Audio and video fade in and fade out periods |
| “Smart” Scan | Direction |
| | Number of segments to advance/retreat |
| | Segment “theme” patterns |
| | Period of time to offset into segment |
| | Base of offset (start or end) |
| | Period of time to playback |
| | Audio and video fade in and fade out periods |
| Play | Duration |
| | Smart or default playback mode |
| Pause | Duration |

One example of a personalized nagivational control is a button configured to “replay the last two seconds of the segment previously viewed.” This macro button could be as follows: smart skip, in reverse, one segment, no theme change, offset two seconds, from end of segment, with zero fade in; play, for two seconds, in default mode; and resume prior navigation operation.

As it may be observed, the browsing and playback capabilities previously described provide the user with the ability to view the entire video or the interesting parts of the video (e.g., sports content or other types of content) in addition to non-linear navigation from one segment to another. The browsing and playback functions may be enabled by a summary description (i.e., segmentation description) that identifies in some manner the segments of the program that contain the desired events. The segmentation description may also describe the content if desired. The playback functionality may be supported by a MPEG-7 Summary Description Scheme, a TV-Anytime compliant Segmentation Description Scheme, or any suitable description mechanism. The use of description mechanisms, as opposed to re-encoding of the original video stream itself, permits the effective presentation of the video content without the need to modify the video content itself, if desired.

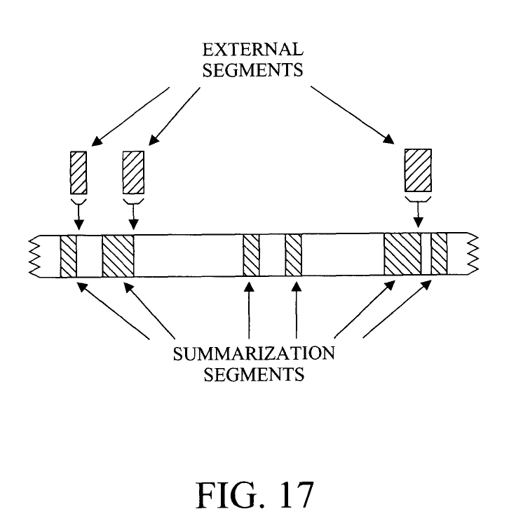

The use of automatic segment identification, such as plays, provides a mechanism for the playback of interesting parts of the video content at the exclusion of non-interesting parts of the video content, which is of assistance to those viewers who do not have sufficient time to watch the entire video content. While such a video summarization is of value to many viewers, the present inventors have come to the realization that the viewing experience of such a summarized video presentation may be, at times, too intense and concentrated for many relaxed viewers. In addition, such summarized video content omits some of the commentary that normally exists between such segments that provides additional insight into the activity itself, such as player statistics and background information. Accordingly referring to FIG. 17, the present inventors came to the realization that there is indeed an enhancement to the viewing experience by including additional video segments between the identified segments, and preferably segments related to the segments themselves as opposed to simply advertising. For example, archival video content about a particular player may follow his play in the current game (e.g., a play of the star pitcher may by followed by a segment showing his play that ended last season's championship game), or video showing data with up-to-date statistics following a play. However, advertising may likewise be provided, if desired. The inclusion of the additional content within a video summarization reduces the intensity of the video content to a level more suitable for casual viewers, while likewise potentially enhancing the viewing experience by providing additional information related to the content of the video.

In many cases the process of presenting a video in a summarized manner will omit many, if not all, of the commercial content of the video. Since content providers rely on commercials for much, if not substantially all, of their revenue the omission of commercial content is undesirable for many content providers. With the capability of including external video segments this enables content providers to include selected advertisements, as desired, which increases their advertising revenue. Moreover, the users may be presented advertisements related to the particular video, such as the sports team or league promotions, thus increasing the user's experience. In some cases, the external advertisement segments may be included in the playback where these segments are shorter than those advertisements in the original broadcast, and thus in many cases more targeted to the particular user and/or the summarization. For example, the external advertisements may have an mean duration that is 75%, 50%, 25% or less than the mean duration of the advertisements in the original video or broadcast together with the original video. This provides the capability for advertisers to provide advertising that is more recent than the original broadcast, more tailored to the particular user viewing the content (such as based upon a profile of the user), and/or more targeted to the user.

As it may be observed, the inclusion of the external segments in the playback does not necessarily need to be stored within the original broadcast video nor does the encoding of the original video need to be modified to present the external segments to the viewer. Rather, the segmentation description enables the browser to include segments from external content during playback of the segments of the original video. For example, the external content may be separately stored by the user on the playback device or an associated device, stored at a server at a location remote from the user, or otherwise at a remote location from the user. The external segments may be provided to the user prior to or during the viewing of the video, provided that they are available to the user at the time of viewing of the video. In the case of a personal video recorder (e.g., TiVo) or otherwise a personal computer the external segments may be stored on the personal video recorder or personal computer.

As it may be observed, a segmentation based description offers the video provider with increased efficiency and flexibility in that different viewer experiences may be realized for the same video (e.g., according to different personal profiles) by using different segmentation descriptions without changing or otherwise modifying the encoding of the original video content. In addition, different subsets of external segments may be effectively selected by the user from a single set of segments via different segmentation descriptions.

### EXEMPLARY EMBODIMENT ONE

### Service-Side Summarization and Persistent Storage By The User

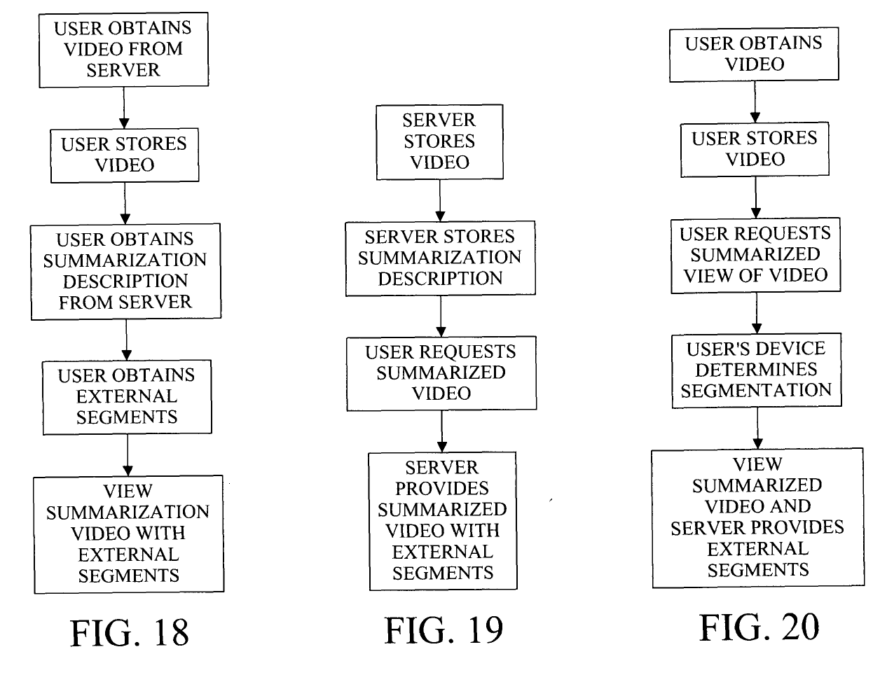

Referring to FIG. 18, one exemplary model for implementing various aspects described above includes a server remote from the user that identifies the segments for the summarization of the video. In some cases, the server will be provided with the summarization description from other sources, such as manual segmentation.

The user obtains the video content from the server or any other suitable source. The video content is thereafter stored by the user in some persistent manner. This is in contrast to traditional television broadcast where the signal is broadcast and the user, at most, stores a couple frames of the television broadcast.

The user obtains, in most cases after obtaining the video content, the summarization description from the server or other suitable provider. In some cases, the user may actually obtain the video content after obtaining the summarization description. In either case, the viewer will have the summarization description (or a portion thereof) together with the corresponding video content (or a portion thereof).

At the user's request the service provider or other source provides suitable external segments to the user (e.g., a personal video recorder or personal computer), where the segmentation description is applied to the video content and the external segments are incorporated into the presentation of the video content. The segmentation description may reflect the user's personal preferences and/or demographics for the type of desirable summarization selected by the user based upon the segmentation description, and the type of external content (e.g., type of commercials). In many cases, the number of and the nature of the external segments may be determined according to a protocol between the user and the service provider. For example, a user that does not desire to consume commercials or prefer external segments that contain content-related material may have to pay relatively more for the service than a user who accepts commercials. In this manner, different service profiles (defined in any manner or arrangement) may be used, each incorporating a different business model.

In particular to an implementation compliant with the TV Anytime standard framework, each content is uniquely identified by a content reference ID (i.e., a CRID-Content Reference Identification). A CRID may identify a single piece of content, or it may resolve into multiple CRIDs, each of which may identify a particular content. A CRID that resolves into multiple other CRIDs is called a group CRID. To enable the use model in question, a group CRID for the original broadcast program and the set of all candidate commercials that may be inserted is assigned by the service provider. It is assumed that the program and each of the commercials have unique CRIDs. Alternatively a single audio-visual stream comprising multiple commercials may be utilized, in which case a single CRID is sufficient to reference the entire set of commercials. Individual commercials are then identified and selected by means of another segmentation description.

The GroupInformation description for the collection of programs is constructed at the service side, with segment group type set to “programCompilation.” This is used by an application to determine how the given group CRID is interpreted.

The segmentation description for the enhanced summary may be generated by the service provider in the following manner:

The automatic summarization of the original video content is carried out by the service provider. This analysis yields a set of time indexes that defines the start and end points of the summary segments in the original video content.

Using the time indexes obtained, descriptions of the segments to be played back in succession are generated. Each of these segment descriptions includes references to the CRID of the original program or commercial that the segment belongs to (as opposed to the group CRID). For maximum flexibility one segment may be defined for each commercial available in the program group.

To enable the playback of the segments, a segment group, with a segmentGroupType that defines continuous playback (e.g., “highlights”), is defined. This segment group references the group CRID, and its SegmentList element provides the list of segments to be played back in succession, in the proper order.

To accommodate multiple demographics, multiple such segment groups can be defined, each of which references the appropriate set of commercials for the given demographic.

To view the enhanced summary, the user first records the broadcast summary and stores it locally (e.g., on a personal video recorder or personal computer).

The user then sends a request to the service for summarized viewing of the program. Upon user's request, the segmentation description is sent by the service provider to the user, along with the external enhancement segments (in this case, commercials) to be inserted. Transmission of the description and the external segments need not be synchronous. The external segments may be uploaded to the user's system (e.g., personal video recorder or personal computer) prior to the broadcast of the original program, during “idle” time.

When the user engages a browser, such as a TVA compliant browser, to view the enhanced summary, the content that is referenced by the segmentation description (i.e., the broadcast programs and the segments to be played) is matched to the content stored on the user's device, and the enhanced summary is presented to the user.

The external segments may likewise be used as the basis for alternatives to the original segments, such as for example, different camera angles that were not featured in the original broadcast. This functionality may be supported by a modification of the segmentation descriptions provided to the viewer. Exemplary options are as follows:

Multiple segment groups, each one comprising a particular set of segments (i.e., alternative summaries) may be generated as part of the segmentation description.

These groups are subsequently collected into another segment group of type “alternativeGroups”. This particular segment group type signals that each of its member groups represents an alternative summary presentation. Every member segment group in the parent segment group is a different version of the program which can be offered by the service provider.

Another option is to introduce a specific extension to the TV Anytime compliant segmentation description. The extension to SegmentInformationType data type, which is used to define and describe individual segments, may be defined as follows:

```
<complexType name=”SegmentInformationExtendedType”>
    <complexContent>
        <extension base=”tva:SegmentInformationType”>
            <attribute name=”alternatives” type=”IDREFS”/>
        </extension>
    </complexContent>
</complexType>
```

The attribute referred to as “alternatives” provides a list of references to other segments that may be used to replace the given segment. Note that the same functionality may be implemented in a variety of ways; e.g., using elements, other referencing mechanisms, etc. Additional descriptive information may be associated with each alternative replacement segment, to signal to an external application the appropriate circumstances for using a particular segment in place of another. The “alternatives” permits a single “base” segment group to be defined and utilized. The technique of using additional segment groups need not be provided for each alternative presentation. The decision on which of the available segments to offer to the viewer is then made on the client side, based on the preferences or profile of a particular user.

### EXEMPLARY EMBODIMENT TWO

### Service Side Summarization and Remote/Networked Personal Video Recorder

Referring to FIG. 19, a modified model differs from service-side summarization and persistent storage by the viewer, in that the viewer side does not require local persistent storage to engage the summarized playback functionality. Instead, a networked personal video recorder, or a video-on-demand (VOD) based function may be used, where the enhanced content is offered by the service provider as part of a VOD service.

The segment detection and summarization may be performed at the service side.

The original program is stored at a remote server (e.g., networked personal video recorder). External segments and the segmentation description are also stored remotely.

The viewer requests from the service a summarized viewing of the program.

Upon viewer request, the service provider provides the user browsing and playback capability incorporating external segments. The segmentation description may reflect the user's personal preferences, demographics for the type of summarization, and for the type of external content (e.g., type of commercials). The amount and the nature of external segments may be determined according to an agreement between the user and the service. For example, a user that does not desire to consume commercials, or prefer external segments that feature content-related material to commercials, may have to pay relatively more for the service than a user who accepts commercials.

The realization of this use model with the TV Anytime tools is similar to that for the Service-Side Summarization and Persistent Storage By The Viewer. The segmentation descriptions that define the enhancements to the original program are similar. The primary difference between the two models is that in the former both the content (original program and enhancement segments) and the segmentation description should be physically available at the client side, while in the latter they may reside at the service side, where the enhanced summaries are dynamically generated and presented to the user at the time of request.

### EXEMPLARY EMBODIMENT THREE

### User-Side Summarization

Referring to FIG. 20, a modified model differs from the previous two models in that play detection may be performed at the user side. The characteristics may be as follows:

User records the broadcast program in local persistent storage.

User requests summarized viewing of the program.

Upon user's request, play detection is performed at user's device. A first segmentation description is generated at user's device containing descriptions of play segments. The service is notified for delivery of external segments to user's platform.

The service delivers the external segments to user's device, as well as information about the desired location of these external segments. The first segmentation description is updated according to this additional information to generate a second description that is utilized in browsing and playback. The external segments may reflect user's personal preferences or demographics for the type of external content (e.g., type of commercials). The amount and the nature of external content segments may be determined according to an agreement between the user and the service. For example, a user that does not desire to consume commercials, may pay relatively more for the service than a user who accepts commercials.

The technique of use may be as follows:

When the user requests a summary of a program previously recorded on the user's device, the device at the user side (e.g. a set-top box (STB)) generates the summary of the original program. This summary is comprised of, say 4 segments (S₁ thru S₄) containing plays, which are collected into a segment group of type “highlights.” The segmentation description utilizes the CRID of the original program only; namely, CRID_{A}.

At the service side, the provider generates a segmentation description that defines, for the original program, the temporal instances (in this example, 4 instances) where commercials should be inserted. This is achieved by defining 4 segments (C₁ thru C₄) of zero duration, and collecting these into a segment group of type “insertionPoints.” Again, the segmentation description utilizes the program CRID, CRID_{A} only.

Given the segmentation descriptions above, the STB may now construct an “enhanced” version of the summary it has extracted from the original program. The new segmentation description is a program compilation comprised of the summary segments plus external segments, and is generated as previously described. The relative position of the play segments are external segments which are determined from the insertionPoints defined with respect to the same temporal reference (i.e., the timeline of the original program), the locations in the summary where the commercials should be inserted can be determined. Note that in some cases, the segments in the original summary need to be modified or redefined, because the commercial insertion points may fall into these segments (e.g. S₃ and S₄ in). However, if/when the provider has information about the temporal positions of commercials in the original broadcast, the provider may choose the insertion points within original commercial breaks. In this case, insertion points for new commercials will not fall into the play segments. This is because play detection methods only detect plays but not commercials. In this case, the group CRID, which contains the program CRID (CRID_{A}) along with the CRIDs of the commercials, for the enhanced summary can be pre-assigned by the service provider, or generated in the STB. In the latter case, the box should already have the required content (i.e. location resolution should not be necessary), since resolution information about this new group CRID will be unavailable outside of the STB.

There are a few additional issues that should to be noted about this model:

The current TV Anytime Metadata specification does not specify the actual content that is to be inserted at a particular insertion point when the insertionPoint type is used. In this embodiment, the system may utilize the RelatedMaterial element of each segment description for this purpose. A RelatedMaterial description is instantiated for each insertionPoint segment, which refers to the external segment via a URL. This mechanism also allows multiple alternative segments to be considered at every insertionPoint. Given a multiplicity of insertion segments, the decision on which one to present to the user may be made by the STB, based on the preferences or past viewing history of the user.

Associated with a group CRID is a program group description. This description may be generated either on the server or the client side, depending on where the group CRID for the compiled program is assigned.

In other embodiments, the segmentation description may contain descriptions of event or play segments that are not in the original program. In particular, the segmentation description may describe a program compilation that is made of an original program and external segments, without describing any event play segments. It is also possible that the original program in such cases may be a summary program, i.e., a single stream containing a summarized and shorter version of an original program, and the segmentation description may be used to incorporate external segments (e.g., commercials) to the summary program.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A method of presenting a video comprising a plurality of frames comprising:
(a) identifying a plurality of segments of said video based upon a segmentation description, where each of said segments includes a plurality of frames of said video; and
(b) identifying at least one external video segment not included within said video;
(c) presenting said plurality of segments to a viewer, while free from presenting at least a plurality of frames not included within said plurality of segments of said video, together with said at least one external video segment.

2. The method of claim 1 wherein at least one of said plurality of segments is a sport.

3. The method of claim 1 wherein said at least one external video segment is related to the content of said video.

4. The method of claim 1 wherein said at least one external video segment is an advertisement.

5. A method of presenting a video comprising a plurality of frames together with a plurality of commercials comprising:
(a) a content provider identifying a plurality of segments of said video based upon a segmentation description, where each of said segments includes a plurality of frames of said video; and
(b) said content provider identifying at least one external advertisement video segment not included within said video;
(c) presenting said plurality of segments to a viewer, while free from presenting at least one of said commercials, together with said at least one external advertisement video segment.

6. The method of claim 5 wherein at least one of said plurality of segments is a sport.

7. The method of claim 5 wherein said at least one external video segment is related to the content of said video.

8. The method of claim 5 wherein said content provider charges advertisers for the inclusion of said at least one external advertisement video segment while presenting said plurality of segments and said at least one external advertisement video segment.

9. A method of presenting a video comprising a plurality of frames comprising:
(a) identifying a plurality of segments of said video based upon a segmentation description, where each of said segments includes a plurality of frames of said video; and
(b) identifying at least one external advertisement video segment not included within said video; and
(c) presenting said plurality of segments to a viewer, together with said at least one external advertisement video segment, wherein the mean duration of said at least one external advertisement video segment is 75% or less than the mean duration of the advertisements originally within said video.

10. The method of claim 9 wherein at least one of said plurality of segments is a sport.

11. The method of claim 9 wherein said at least one external video segment is related to the content of said video.

12. The method of claim 9 wherein said mean duration is 50% or less.

13. The method of claim 9 wherein said mean duration is 25% or less.

14. A method of presenting a video comprising a plurality of frames comprising:
(a) identifying a plurality of segments of said video based upon a segmentation description, where each of said segments includes a plurality of frames of said video; and
(b) identifying at least one external advertisement video segment not included within said video; and
(c) presenting said plurality of segments to a viewer, together with said at least one external advertisement video segment, wherein the mean duration of said at least one external advertisement video segment is 75% or less than the mean duration of the advertisements originally broadcast with said video.

15. The method of claim 14 wherein at least one of said plurality of segments is a sport.

16. The method of claim 14 wherein said at least one external video segment is related to the content of said video.

17. The method of claim 14 wherein said mean duration is 50% or less.

18. The method of claim 14 wherein said mean duration is 25% or less.

19. A method of presenting a video comprising a plurality of frames comprising:
(a) a content provider identifying a plurality of segments of said video based upon a segmentation description, where each of said segments includes a plurality of frames of said video; and
(b) said content provider identifying at least one external advertisement video segment not included within said video;
(c) presenting said plurality of segments to a viewer, together with said at least one external advertisement video segment, in a manner such that a different number of said at least one external advertisement video segments are included based upon a service profile.

20. The method of claim 19 wherein at least one of said plurality of segments is a sport.

21. The method of claim 19 wherein said at least one external video segment is related to the content of said video.

22. The method of claim 19 wherein said content provider charges advertisers for the inclusion of said at least one external advertisement video segment while presenting said plurality of segments and said at least one external advertisement video segment.

23. A method of presenting a video comprising a plurality of frames comprising:
(a) identifying a plurality of segments of said video based upon a segmentation description, where each of said segments includes a plurality of frames of said video; and
(b) identifying at least one external video segment not included within said video that is representative of an alternative to a segment of said video;
(c) presenting said plurality of segments to a viewer together with said at least one external video segment.

24. The method of claim 23 wherein at least one of said plurality of segments is a sport.

25. The method of claim 23 wherein said at least one external video segment is an alternative camera angle.
